(19) United States
(12) Patent Application Publication
(10) Pub. No.: US 2006/0201783 A1
(43) Pub. Date: Sep. 14, 2006

(54) Conveyor belt wiper

(76) Inventor: Alan D. Baldasari, Negaunee, MI (US)

Correspondence Address: BANNER & WITCOFF, 1001 G STREET N W, SUITE 1100, WASHINGTON, DC, 20001, US

(21) Appl. No.: 11/074,934

(22) Filed: Mar. 9, 2005

(51) Int. Cl. B65G 45/16

(52) U.S. Cl. 198/499

(57) ABSTRACT

A belt cleaning system for a conveyor belt is provided having a flexible wiping blade that may include a plurality of fingers. The belt cleaning system may include a spray wash bar that provides water and/or air to a conveyor belt ahead of the wiper blade along the direction of flow of the conveyor belt. The wiper blade may be oriented such that the tip of the wiper blade opposes the direction of belt travel. The belt cleaning system may include a blade locking mechanism for securing the wiper blade that employs a rocker bar to rock a blade clamp into the blade. The belt cleaning system may also include multiple spray nozzles that direct wash water in multiple directions. The belt cleaning system may further include tensioning mechanisms to bias the wiper blade against the belt.

### TECHNICAL FIELD

This invention relates generally to conveyor belts. More particularly, the invention relates to a conveyor belt wiper, a conveyor belt wiping system and a method for cleaning particles from a conveyor belt.

### BACKGROUND

Conveyor belt cleaning systems remove particles from a moving conveyor belt. Conventional conveyor belt cleaning systems do so by scraping the belt as bulk material carried thereon is dumped from the belt. The conventional systems place a non-interrupted, rigid blade against the conveyor belt at a location where the belt is turned about a head pulley. The non-interrupted, rigid blade scrapes bulk material that clings to the belt after it dumps most of the bulk material.

FIGS. 1, 2A and 2B show conventional conveyor belt cleaning systems. The conventional conveyor belt cleaning system 110 shown in FIG. 1 includes a flexible belt 112 carrying bulk materials 114 that curves about a rotating head pulley 116. As the belt curves around the head pulley, the bulk materials fall from the belt. A scraping blade 118 assists with the removal of fine materials and other particles of the bulk materials that remain attached to the belt as it curves around the head pulley by pressing a scraping edge against the belt and the head pulley. Conventional scraping blade 118 shown in FIG. 1 is made from a non-interrupted blade 120 that extends across the central portion of the belt to remove the fine materials that are concentrated therein. Non-interrupted blade 120 is coupled to an axle 122, which permits the blade to rotate into a contact position with the conveyor belt.

FIGS. 2A and 2B show another conventional conveyor belt cleaning system. The conventional conveyor belt cleaning system 210 shown therein is similar to system 110, except that it includes a non-interrupted scraping blade 220 that is fixed in a position proximate to the conveyor belt 212 as it curves around the head pulley 216. As shown in FIG. 2B, a space 224 exists between the scraping blade and the head pulley through which belt 212 fits during operation. However, a small gap 226 typically forms over time between the scraping blade and the belt as the belt wears or as the scraping blade shifts. Fine materials remaining on the belt after it dumps may pass through the small gap without being removed by the scraping blade.

Cleaning systems 110 and 210 each attempt to dislodge bulk materials remaining on the conveyor belt at the head pulley where the materials are dumped. They rely on a tight fit of the scraping blade against the surface of the conveyor belt, which allows small particles to remain on the belt when the fit is not sufficiently tight. These conventional non-interrupted, rigid blades do not accommodate for variations in the belt thickness across the width of the belt or for other inconsistencies across the width of the belt, such as bumps or ripples. Further, these conventional scraping blades operate by sandwiching the belt between the head pulley and the blade, which causes the belt to wear.

Accordingly, a need exists for improved methods of cleaning bulk materials from conveyor belts, for improved conveyor belt cleaning systems, and for improved conveyor belt wipers.

### SUMMARY

The present invention generally provides a conveyor belt wiper, a conveyor belt wiping system, and a method for cleaning a conveyor belt. According to an embodiment of the invention, a conveyor belt wiper includes a flexible wiper blade that can be flexed against a conveyor belt. The wiper blade may include a plurality of independently flexible blade fingers. According to another embodiment of the invention, a wet belt cleaning system includes a spray wash bar and a wiper blade. The spray wash bar may provide water and/or air to a conveyor belt ahead of the wiper blade along the direction of flow of the conveyor belt to dislodge materials thereon. The spray wash bar and the wiper blade could be contained in a single unit or they could be separate systems. The wiper blade may be oriented such that the tip of the wiper blade opposes the direction of belt travel.

Aspects of the invention further provide a blade locking mechanism for securing the wiper blade, which employs a rocker bar to rock a blade clamp into the blade. Other aspects include multiple spray nozzles to direct wash water in multiple directions. Further aspects include tensioning mechanisms to bias the wiper blade against the belt. Other features and advantages of various aspects of the invention will become apparent with reference to the following detailed description and figures.

### BRIEF DESCRIPTION OF THE DRAWINGS

The invention will be described in detail in the following description of preferred embodiments with reference to the following figures wherein:

FIGS. 1, 2A and 2B show prior art conveyor belt wiping systems.

FIG. 3 is a side view of a conveyor belt wiping system according to an embodiment of the invention.

FIG. 4 is a perspective view of a conveyor belt wiper blade according to an embodiment of the invention, which may be used with the system of FIG. 3.

FIG. 5 is a close-up view of a portion of the conveyor belt wiping system of FIG. 3.

FIGS. 6A and 6B respectively show a side view and a top view of a spray nozzle of the conveyor belt wiping system of FIG. 3.

FIG. 7 is a front view of the conveyor belt wiper of the system of FIG. 3.

FIG. 8 is a cut-away view along lines 8-8 of a portion of the conveyor belt wiper of FIG. 7, which shows a tension arm and a pipe coupling of the conveyor belt wiper.

FIG. 9 is a side view of a conveyor belt wiper according to another embodiment of the invention.

FIG. 10 is a side view of a conveyor belt wiper according to a further embodiment of the invention.

FIGS. 11A and 11B respectively are top and front views of the conveyor belt wiper of FIG. 10.

FIG. 12 is a side view of a conveyor belt wiper according to yet another embodiment of the invention.

FIG. 13 is a side view of an adjustable bracket for the spray bar of the conveyor belt wiper of FIG. 12.

### DETAILED DESCRIPTION OF THE PREFERRED EMBODIMENTS

The various aspects of the invention may be embodied in various forms. The following description shows by way of illustration various embodiments in which aspects of the invention may be practiced. It is to be understood that other embodiments may be utilized and structural and functional modifications may be made without departing from the scope of the present invention.

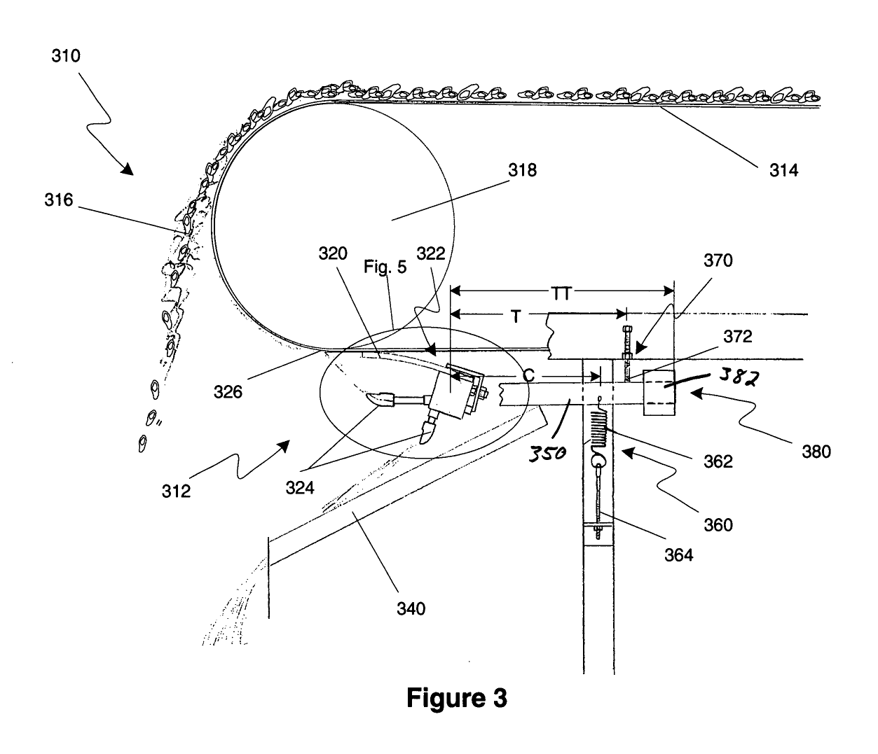

Referring now to FIGS. 3-8, a conveyor belt wiping system 310 according to embodiments of the invention is generally shown, which cleans fine material particles that cling to the surface of a conveyor belt 314 after the belt has dumped bulk materials 316 carried on it and has traveled around a head pulley 318. As shown in FIG. 3, conveyor belt wiping system 310 generally includes a conveyor belt wiper 312 coupled with the conveyor belt proximate to the head pulley. The conveyor belt wiper 312 generally includes a wiper blade 320, a wiper body 322 supporting the wiper blade, and one or more spray nozzles 324 attached to the wiper body. During operation, the wiper body flexes the wiper blade against a lower, return side 326 of the conveyor belt to dislodge fine materials that may remain on its return side after it travels around the head pulley. Spray nozzles 324 spray water, air, or another fluid on the belt proximate the location where the wiper blade contacts the belt, which assists with removing fine materials from the belt.

The conveyor belt 314 is generally suspended between the head pulley and a tail pulley (not shown) and/or other supports. As such, the conveyor belt is wrapped tightly about head pulley, but has play in suspended portions between supports. Placing the wiper blade 320 against a suspended portion of the conveyor belt, such as after it exits the head pulley, provides the belt with flexibility to move vertically as needed when the conveyor wiper blade encounters variations in the belt. This reduces belt wear in comparison with systems that sandwich the belt between the wiper blade and the head pulley. In addition, placing the conveyor belt wiper 312 proximate to the head pulley allows fine materials wiped from the belt to be guided via a tray 340 toward the dumping location for the bulk materials 316.

Wiper blade 320 may be made from a material that has excellent endurance and flexibility characteristics, and that may has low abrasion properties for permitting direct contact against the conveyor belt, such as a resilient plastic polymer or a resilient composite that includes carbon fibers. It is understood, however, that other resilient materials may be used for the wiper blade, such as tungsten carbide, steel, acrylic, resin, urethane, polycarbonate, carbon fibers, etc. It is further understood that these materials may be used along with other materials that enhance the overall performance of the wiper blade, such as ceramic or tungsten carbide wear pads at the tip of the wiper blade. It is additionally understood that the sheet thickness can vary depending on properties such as desired resiliency, wear characteristics, and the physical size of the application. Wiper blade 320, when made from a plastic polymer, provides a wiper blade that causes very little belt wear while effectively scraping the belt.

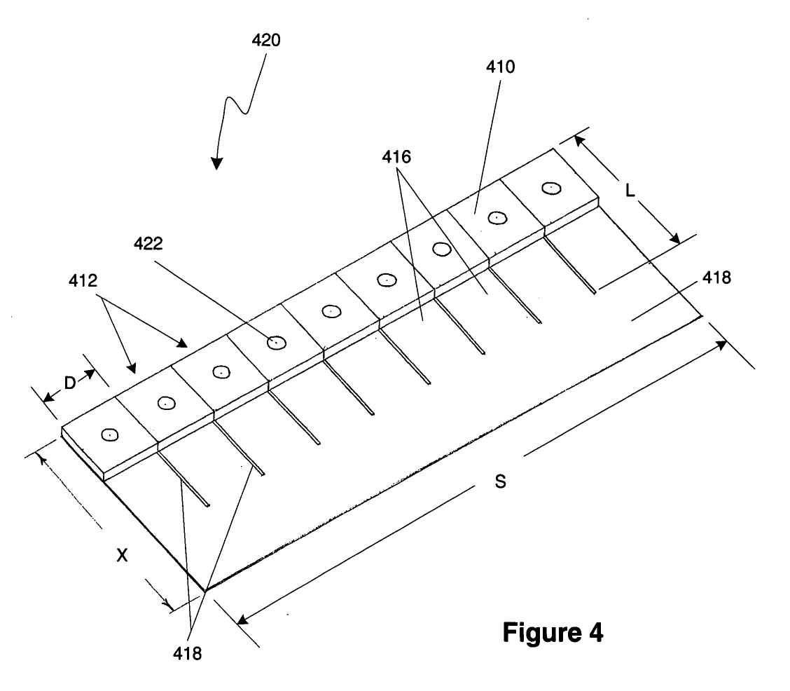

Referring now to FIG. 4, an optional wiper blade embodiment 420 is shown that includes a support blade 418 and wear blocks 410 attached thereto. The support blade may be made of stainless steel or another robust, flexible material, and the wear blocks may be made from ceramic, tungsten carbide, a polymer, or other such material having desirable wear characteristics. The wear blocks 410 are bolted to tip region 412 of the support blade for making sliding contact with the conveyor belt. As shown, individual wear blocks 410 are attached to the support blade via a hole pattern near the leading edge of the blade, which permits the addition of wear blocks without affecting the individual moveability of fingers 416 (discussed below). In the configuration shown, each wear block is a ceramic block that has a countersunk hole 422 cast into it and that is supplied with a steel grommet to help distribute bolt torque stress. To further increase blade life, the ceramic blocks may be reversed to provide a new cleaning edge after the first side wears. The ceramic blocks may be used with or without the water spray mechanism discussed below.

As further shown in FIG. 4, wiper blade 420 includes a series of relief cuts 414 in the support blade 418 that create individually movable fingers 416 therein. When flexed against the conveyor belt during use, the independent fingers can generally contour as needed to match belt irregularities or worn spots. In one configuration, the relief cuts between the fingers may be spaced a distance D from 1 to 6 inches apart. Preferably, the cuts are spaced 2 to 4 inches apart and more preferably they are spaced about 3 inches apart. The length L of the cuts can be from 1 to 8 inches in length. Preferably, their length is 3 to 5 inches and is more preferably about 4 inches, which provides fingers with good flexibility and resiliency. The relief cuts 414 may be about ¼ inch thick or less, and are preferably about ⅛ inch thick or less. The length of the relief cuts and the fingers may be selected to provide a desired flexibility and resiliency. The span S of the wiper blade from the first to the last finger is preferably about the same width of the belt, but it may less than the width of the belt. Wiper blade length X in one configuration may vary from about 6 to 16 inches depending on material resiliency and the desired amount of blade surface area contacting the belt. About 12 inches is a preferred length X of the wiper blade in the configuration of the wiper blade 320 shown in FIG. 4.

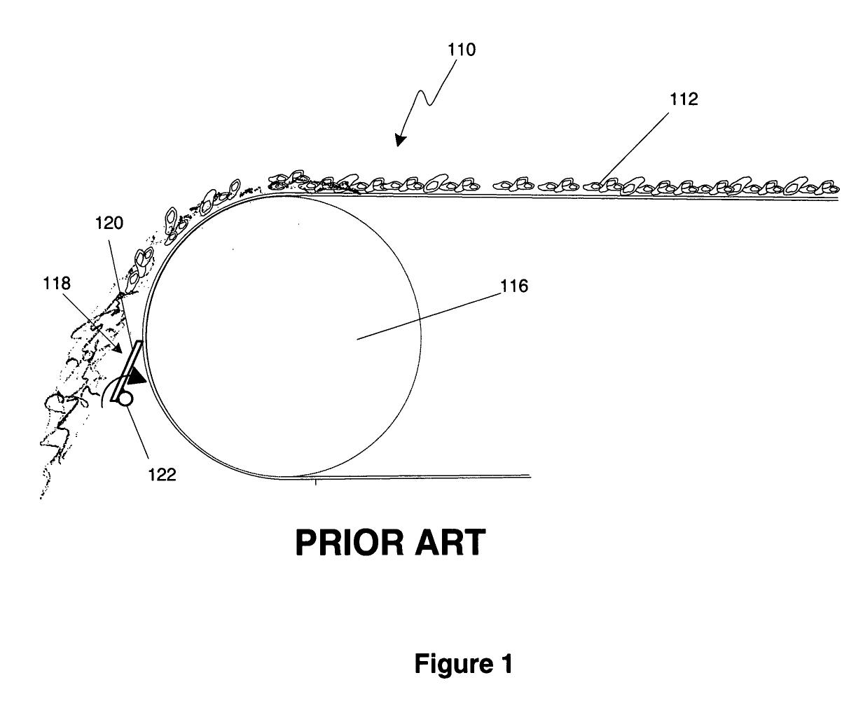

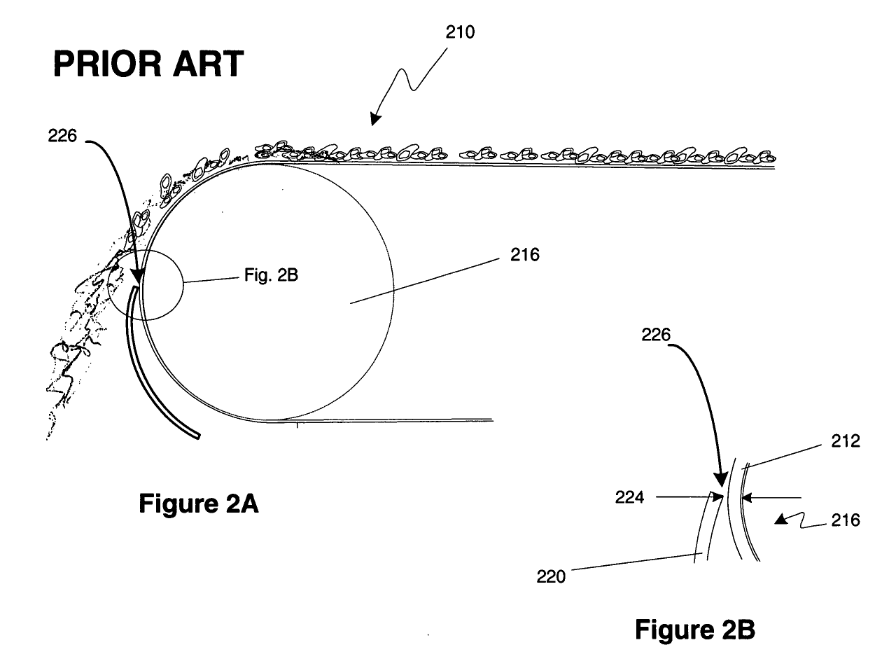

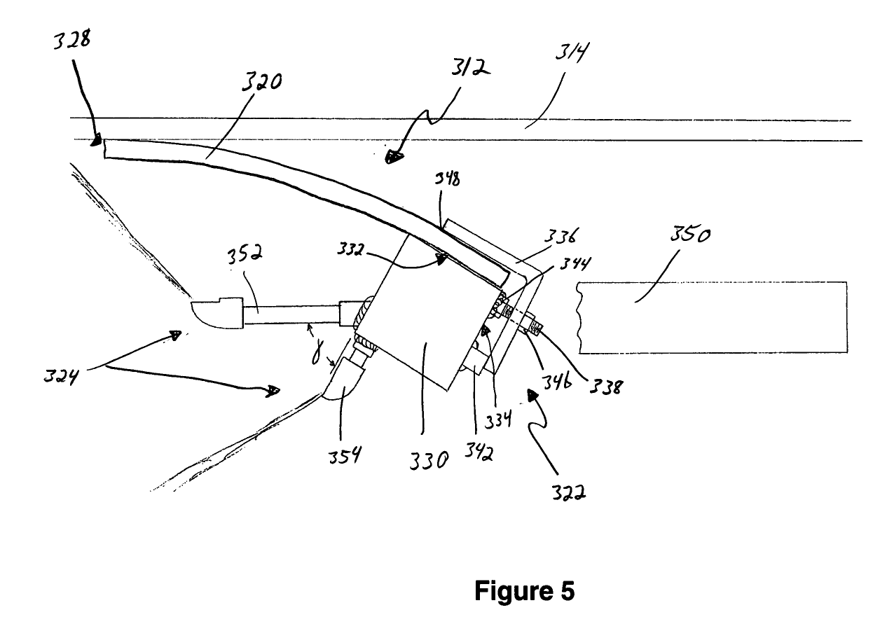

FIG. 5 shows a close-up view of conveyor belt wiper 312, which may include wiper blade 320 shown in FIG. 3, wiper blade 420 shown in FIG. 4, or other configurations of flexible wiper blades. As shown, the wiper blade is oriented so that a contact tip portion 328 opposes the direction of belt flow, which provides effective scraping of fine materials attached to the belt surface. The tip portion 328 is angled slightly away from the conveyor belt as it contacts the belt such that the wiper blade is substantially parallel with the belt where it makes contact. Such a configuration reduces the possibility of the wiper blade and/or the complete assembly from “catching” and rolling or flopping over, which can happen with conventional systems in which the wiper blade has a much larger angle where it contacts the belt. For instance, the wiper blade shown in FIG. 1 is angled about 30 degrees from the conveyor belt at its contact point. As shown in FIG. 5, tip portion 328 may be substantially rectangular such that a square edge contacts the belt. Other configurations are also possible, such as an angled tip or a tapered point. Further, anti-wear mechanisms may be added to tip portion 328 to extend its usable life.

As further shown in FIG. 5, the wiper body 322 may be made from a square or rectangular tube 330, which gives it a pair of perpendicularly oriented faces 332 and 334 along a rear portion of the wiper blade 320. These faces cooperate with an angled blade clamp 336, a clamp bolt 338, and a rocker bar 342 to provide a robust clamping system that permits quick and easy removal of the wiper blade 320 for maintenance or replacement purposes. The rocker bar 342 is welded along the length of rear face 334 of the wiper body. The lower edge of angled clamp 336 rests on top of this bar, which may be made from square metal stock. The height of the rocker bar may be land ½ times the depth of the bolt head of clamp bolt 338 to permit the clamp to rock sufficiently into the blade to lock it in place. The clamp bolt head 344 is welded to the wiper body at rear face 334. The bolt extends through a hole in the angled clamp and a nut 346 is attached to the clamp bolt at an opposite side of the angled clamp 336 from the bolt head. As the nut is tightened, the blade clamp rocks or cams forward, causing a forward edge 348 of the blade clamp to bite into the wiper blade and to lock it in place against face 332. It is understood that a plurality of clamp bolts may be used to sufficiently retain the angled clamp. Face 332 may include ridges or other features to assist with the gripping the wiper blade. The wiper blade can be removed relatively easily by reversing nut 346 to loosen the blade clamp that sandwiches the wiper blade against tubing 330. As an example, the tubing used for the wiper body may be 2 to 6 inches square and may have wall thicknesses from about ⅛ to ½ inch. The size and weight of the material can vary depending on the size of the application and/or the bulk material to be conveyed. As discussed further below, the wiper body 322 may further include a tensioning bar 350 attached to tubing 330 for rotating the clamped wiper blade to bias it against the conveyor belt.

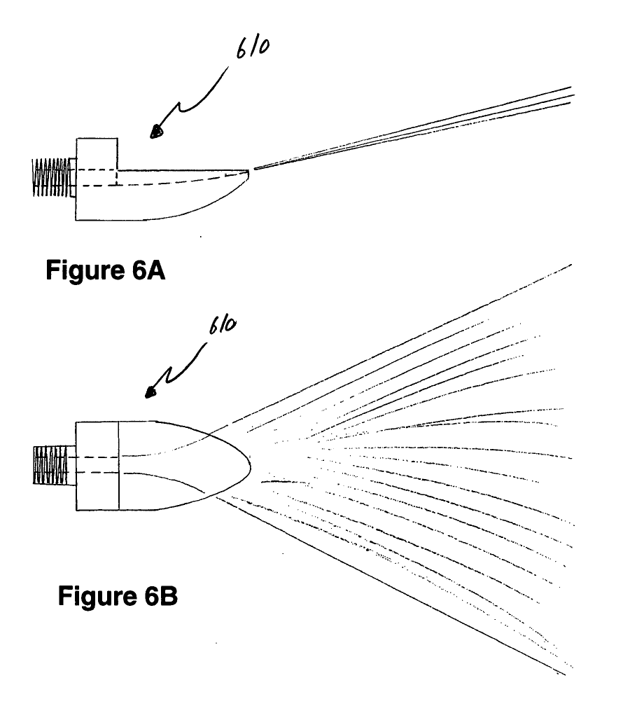

As further shown in FIG. 5, a series of pipe couplings may be welded through holes in tubing 330 on the side of the wiper body facing the blade tip to form one or more spray nozzles 324. In the configuration shown in FIG. 5, conveyor belt wiper 312 includes an upper spray nozzle 352 and a lower spray nozzle 354, which may be located on tubing 330 at an opposite comer from the wiper blade 320. The nozzles and their respective sprays may be oriented at an angle y from each other, which may be about 30° to 150° for both washing the belt and washing away materials that drip from the belt. A nipple for each of spray nozzles 352 and 354 may be oriented 30° to 90° from the surface to which they are respectively welded, and their orientation is preferably about 40° to 50° from their respective attachment surfaces, which permits a pipe nipple to be easily threaded into the coupling. This permits spray nozzles to be added or removed as needed for various spray configurations if multiple nipples are placed along the length of the tubing 330. Unused nipples may be capped until needed. In the configuration shown for conveyor belt wiper 312, the nipple length can vary from 0 to 12 inches with 3 to 6 inches being a preferred length. A spray head is attached to the outboard end of the nipple to form a spray nozzle. FIGS. 6A and 6B show an embodiment of a directional spray head 610 that provides a wide fan-shaped spray. It is understood that other spray heads and corresponding spray shapes may be used.

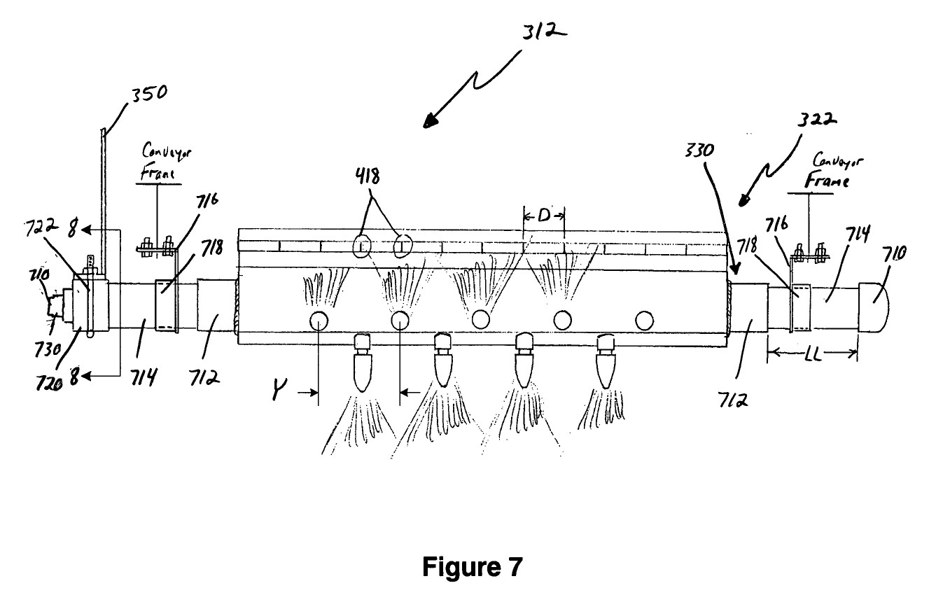

The coupling, nipple, and nozzle assemblies of spray nozzles 324 can be spaced a distance Y apart from each other (see FIG. 7), which can be from 2 to 12 inches apart along the wiper body with 4 to 8 inches being a preferred spacing. A spacing of about 6 inches is even more preferred, which should permit water to be sprayed across an entire belt width. This configuration also sprays the water right in front of the blade tip, which gives the system good cleaning capabilities and also lubricates the blade-to-belt contact area. An advantage of this configuration is that a single assembly supports the blade wiper and provides spray nozzles. Additional coupling, nipple, and nozzle assemblies can be welded to the other surfaces of the wiper body as needed. These can be used to keep fine materials from building up in drip trays or for directing wash water wherever it is needed.

FIG. 7 is a front view of conveyor belt wiper 312. As shown, both ends of tube 330 of wiper body 322 are capped off via caps 710, and pipe couplings 712 are welded to the ends to permit attachment of a support axis 714 for the wiper body. The size of pipe coupling 712 may depend on the size of the wiper body, and the diameter of the coupling may be about 0 to 1 inches smaller than the width of tubing 330. The coupling may accept a length of pipe 714 having a length LL from about 2 to 24 inches. However, 4 to 12 inches is a preferred length in one configuration with 6 inches being more preferred to provide sufficient length to provide a support axle without extending more than necessary. Mounting brackets 716 for the wiper body may be made from angled supports that each has a hole in one side with a short riding sleeve 718 welded to it. The riding sleeve has an inside diameter slightly larger than the outside diameter of pipe 714. A tension arm coupling 720 can be attached to the outboard end of one of the pipe nipples, to which tension arm 350 is attached. The tension arm 350 can be reversed to the opposite side as needed for conveyor frame attachment purposes. In addition, a fluid coupling 730 could be added to one or both ends to supply wash fluid to the wiper body.

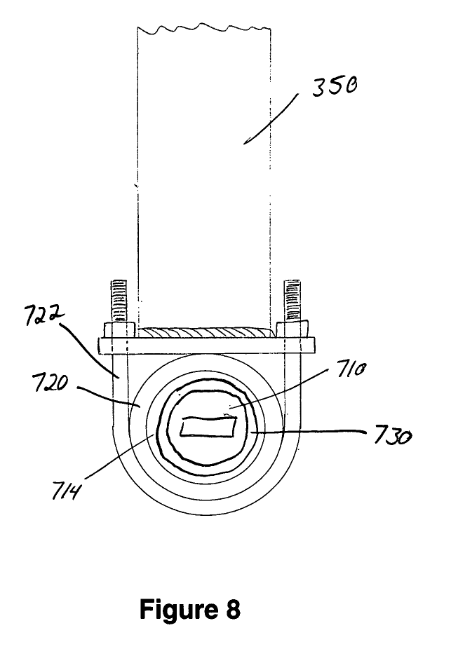

Tension arm 350 can be mounted to either end of conveyor belt wiper 312 as needed for attachment and tensioning purposes. As shown in FIG. 8, tension arm 350 is attached via an attachment mechanism 722, which may be a pipe clamp. Using a pipe clamp or a similar rotatably adjustable attachment mechanism permits the tension arm to securely attach to the circumference of pipe coupling 720, while allowing the tension arm to be rotationally oriented in a desired direction. This provides flexibility for adjusting the tensioning mechanisms and for using various different types of tensioning mechanisms, such as a spring tensioning mechanism, a threaded jack bolt mechanism and a counter weight tensioning mechanism, which are discussed hereafter. The length of tensioning arm 350 can vary depending on the tensioning mechanism used and the particular requirements for attaching to the conveyor belt system.

Returning to FIG. 3, four embodiments of tensioning mechanisms are shown therein. One, all or any combination of these tensioning mechanisms may be used with conveyor belt wiper 322. In a spring tensioning mechanism 360, a tension or compression spring 362 is connected to tensioning arm 350 to bias wiper blade 320 into contact with conveyor belt 314. For the spring tensioning mechanism 360, a relatively short tensioning arm could be used, such as one extending a distance C of 4 to 12 inches from the wiper body axis to the spring attachment point. Preferably, the distance would be about 6 to 8 inches with the spring pulling at about a 90° angle to the tensioning arm. Spring tension could then be adjusted through the use of a threaded eyebolt 364 connected to the opposite end of the spring from the tensioning arm.

A threaded jack bolt tensioning mechanism 370 includes a threaded jack bolt 372 that pushes against tension arm 350. For tensioning mechanism 370, 4 to 12 inches could be the length T of the tension arm with 6 to 8 inches being a preferred length.

A counter weight tensioning mechanism 380 includes a counter weight 382 attached to an outboard end of tensioning arm 350, which may include a tension arm having a length TT of about 10 to 30 inches with the arm in a horizontal position. Variable weight can be attached to the outboard end of the arm to achieve the desired wiper blade tension.

Combinations of these mechanisms may be used as appropriate. Because any of these tensioning mechanisms can work well, the belt cleaning system may be installed in a variety of configurations and for various applications, which simplifies installation of the cleaning system. Furthermore, the use of fingers 412 in the wiper blade coupled with moving the blade-to-belt contact location off of the head pulley provides an effective wiping interface between the blade and the belt while providing flexibility for an acceptable location for mounting the conveyor belt wiper 312.

The conveyor belt wiper 312 may be operated using water, a cleaning solution, pressurized air or another fluid. In an embodiment using air as the fluid, the air stream itself can remove much of the dry particulate that may be clinging to the belt. Moreover, the use of air can serve to loosen or agitate any material that has some moisture in it, which can improve the effectiveness of the wiper blade to scrape it off. The use of directed air to help clean the belt may be desirable in applications where the material and belt must be kept dry. Aligning the spray nozzles in a row, which as shown in FIG. 6 may create flat fan-shaped streams, can form a blade of air or water to effectively assist with the removal of materials clinging to the conveyor belt.

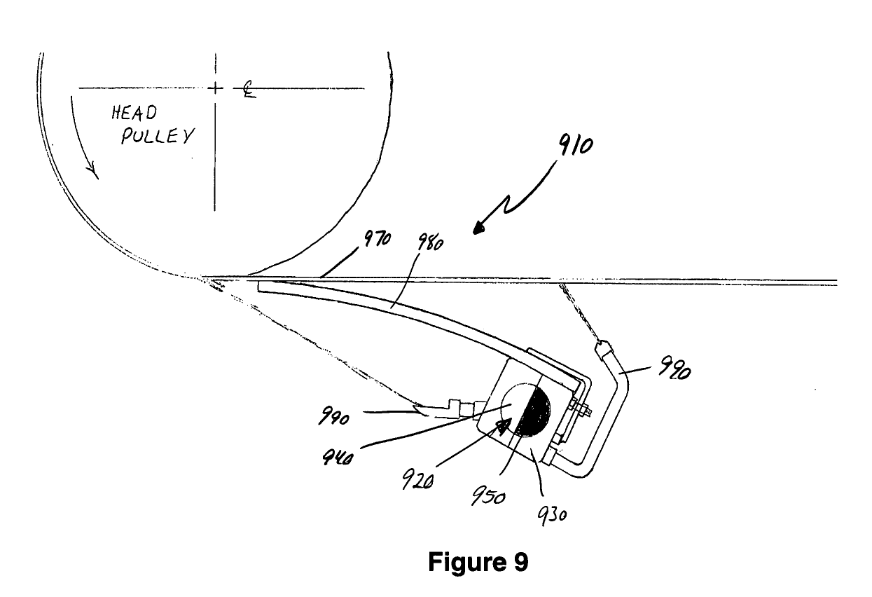

Referring now to FIG. 9, a further embodiment of a conveyor belt wiper 910 is shown, which is similar to the conveyor belt wiper 312 except that it includes a double chamber 920 within pipe 930 of the wiper body. Double chamber 920 may be formed by joining two rectangular tubes together to form a square tube. As an example, two rectangular tubes sized 2″×4″ could be joined to form a 4″×4″ square tube. Capping off one end of one of the 2″×4″ rectangular tubes and capping the other 2″×4″ rectangular tube at the opposite side of the formed 4″×4″ wiper body can permit water or another liquid to be supplied to the front primary chamber 940 and air to the back secondary chamber 950.

Water from the primary chamber may be used to wash the belt surface in front of the wiper blade. As conveyor belt 970 moves past the wiper blade 980, most of the water will be removed. Air may then be routed from secondary chamber 950 via spray nozzles 990 above and behind the wiper body to remove residual water from the belt. This may be an advantageous configuration for keeping water from dripping from the belt as it travels towards the tail pulley (not shown). It would also serve to keep return rollers dry and free of water contamination. The wiper blade may also serve as a barrier between the wet and dry sides of the system, which may prevent the high-pressure air from disturbing the front side water stream. A further embodiment of the invention could employ solenoid-operated valves on either or both the primary and secondary sides. When set up on an electrical or mechanical timer, such an embodiment may allow for time-delayed pulses of air and/or water in any desired combination of frequency and duration.

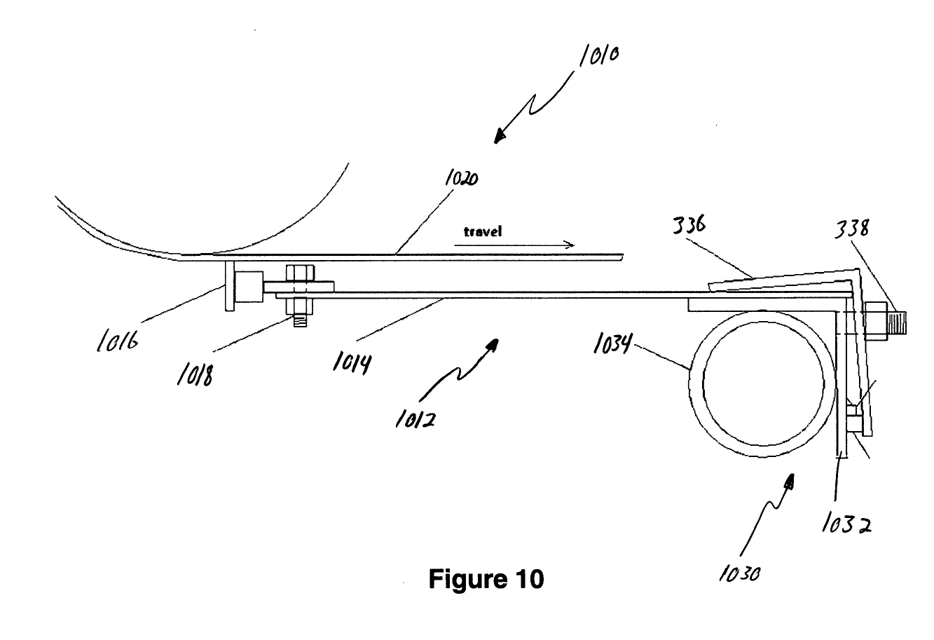

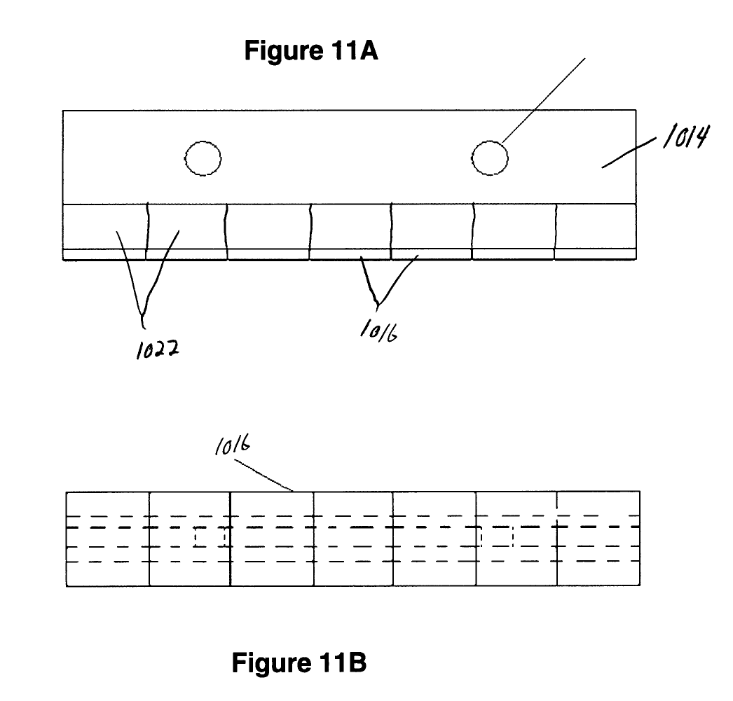

FIG. 10 shows a conveyor belt wiper 1010 according to a further embodiment of the invention. Conveyor belt wiper 1010 generally includes the same aspects and preferences as conveyor belt wiper 312, except that it includes a wiper blade 1012 having a support blade 1014 and a metal tip 1016 made from a metal having good hardness properties. In one example, metal tip 1016 is made of tungsten carbide, which has high hardness properties and wiper blade 1012 is made of stainless steel, which has good strength and flexibility properties. As shown, metal tip 1016 is oriented substantially perpendicular to conveyor belt 1020, which provides an effective scraping edge against the conveyor belt. The metal tip may be attached to a bracket and mounted to the tip region of support blade 1014 via a bolt 1018. The wiper body 1030 shown in FIG. 10 may include an angle bracket 1032 welded to a support pipe 1034. As discussed further below, such a configuration for the wiper body may permit an adjustable spray bar to be mounted to the wiper body. As illustrated in FIGS. 11A-11C, support blade 1014 may include a plurality of fingers 1022 at its tip region, to which an individual metal tip 1016 is mounted to each of the fingers.

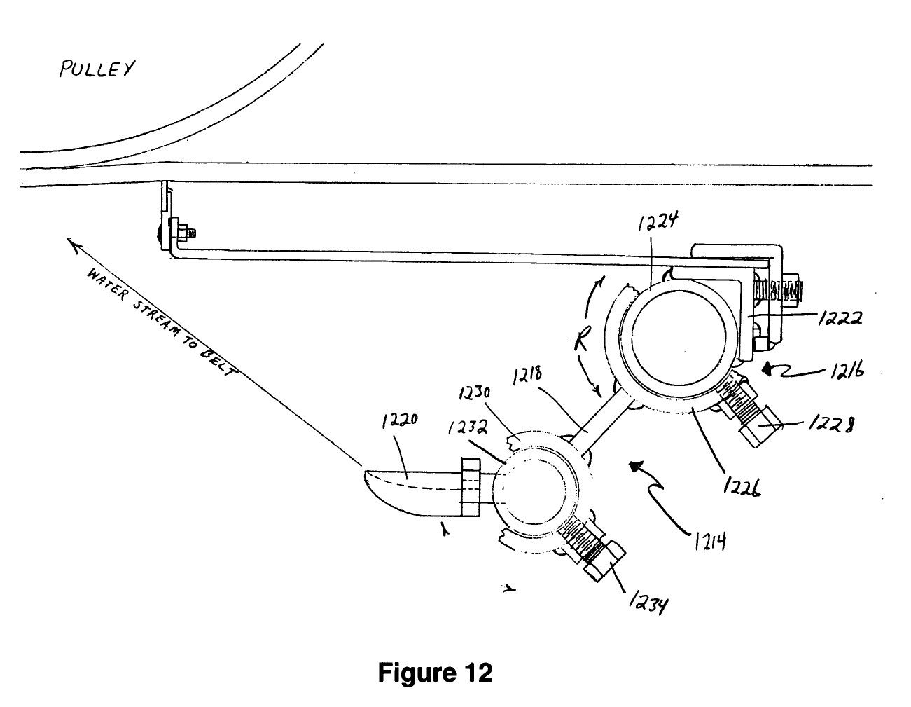

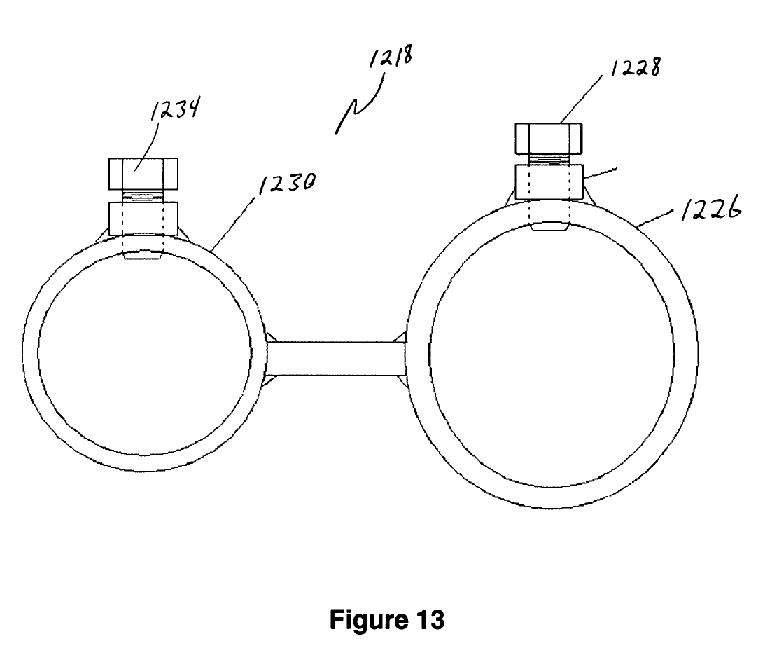

FIG. 12 shows a conveyor belt wiper 1210 according to a further embodiment of the invention. Conveyor belt wiper 1210 generally includes the same aspects and preferences as conveyor belt wiper 1010, except that it includes a separate spray mechanism 1214 from the wiper body 1216. Spray mechanism 1214 removably mounts to wiper body 1216 such that conveyor belt wiper 1210 may be installed with or without the spray mechanism. Spray mechanism 1214 includes an adjustable mount 1218 that permits the spray mechanism to rotate about the wiper body, and that permits a spray nozzle 1220 to be rotated with respect to the adjustable mount. FIG. 13 shows the adjustable mount apart from the spray mechanism.

As shown in FIG. 12, wiper body 1216 includes an angle bracket 1222 welded to a support pipe 1224. A wiper sleeve 1226 of the adjustable mount is disposed about the support pipe to permit the spray mechanism to rotate about the support pipe. In one configuration, the spray mechanism is able to rotate an angle R around the support pipe, which angle may be up to about 180 degrees and may be preferably be about 120 degrees. A setscrew 1228 extends through wiper sleeve 1226 to lock the spray mechanism in a desired angular orientation about the wiper body. The adjustable mount 1218 may also include a spray bar sleeve 1230 through which a spray bar 1232 is mounted, and a spray bar set screw 1234. The spray bar sleeve permits the spray bar to rotate with respect to the adjustable bracket and the wiper body, and the spray bar setscrew locks the spray bar in a desired orientation. As shown, one or more spray nozzles 1220 are attached to the spray bar for spraying a fluid. It is understood that the spray mechanism may include a plurality of adjustable mounts 1218 to provide a secure connection between the spray bar and the wiper body.

The conveyor belt wipers of the embodiments shown in FIGS. 3-12 may provide a variety of advantages. For instance, the combination of the wiping assembly and the spray mechanism into a single unit according to some of the embodiments provides for simplified installation of a single unit. In other embodiments, separate wiping and spraying mechanisms permit flexibility for including or excluding the spraying mechanism and for adjusting the orientation of sprays from the spraying mechanism. Further, a wiper blade oriented in such a way that the blade tip opposes the direction of belt travel provides good belt cleaning characteristics. Also, wiper blades having individually movable fingers that permit the blade to flex in a convex configuration or other configuration against the belt surface provides good belt cleaning characteristics, and allows for constant belt-to-blade contact even when used with a worn or irregular belt. In addition, a blade locking mechanism that employs a rocker bar to rock or cam a clamp into the blade provides a secure mechanism for securing the wiper blade and for providing a simple method for installing and removing the wiper blade. Furthermore, multiple spray nozzle alignments that can direct wash water (and/or air) in more than one direction provides flexibility for adjusting the cleaning system as needed. Additionally, various tensioning mechanisms provide flexibility for installing the system and for achieving proper wiper blade to belt pressure. Although the advantages discussed are demonstrated in the conveyor belt wiper and wiper systems described above, various embodiments are contemplated that make use of only one or more aspects or advantages.

While the present invention has been described in connection with the illustrated embodiments, it will be appreciated and understood that modifications may be made without departing from the true spirit and scope of the invention. In particular, the invention applies to many different types of conveyor systems and various configurations of belt cleaning systems.

I claim:

1. A conveyor belt wiper comprising:
a wiper blade support;
a flexible wiper blade attached to the wiper blade support; and
a tensioning mechanism flexing the flexible wiper blade against a conveyor belt when operatively connected to a conveyor belt system.

2. The conveyor belt wiper of claim 1, wherein the flexible wiper blade includes a plurality of independently flexible fingers.

3. The conveyor belt wiper of claim 1, wherein the flexible wiper blade includes a wear block attached to a proximate end of the flexible wiper blade for contacting the conveyor belt when operatively connected to the conveyor belt system.

4. The conveyor belt wiper of claim 3, wherein the flexible wiper blade comprises carbon fiber and the wear block comprises one of plastic and ceramic.

5. The conveyor belt wiper of claim 3, wherein the flexible wiper blade comprises stainless steel and the wear block comprises tungsten carbide.

6. The conveyor belt wiper of claim 1, further comprising a sprayer spraying a fluid at the conveyor belt when operatively connected to the conveyor belt system.

7. The conveyor belt wiper of claim 1, wherein the wiper blade support includes an axle permitting rotation of the wiper blade against the conveyor belt when operatively connected to the conveyor belt system, and further comprising a spray bar movably attached to the axle.

8. The conveyor belt wiper of claim 1, wherein the wiper blade support includes a first support surface abutting a rearward portion of the wiper blade and a second support surface disposed at an angle from the first support surface, the belt wiper further comprising a blade clamping mechanism removably attaching the flexible wiper blade to the wiper blade support, the blade clamping mechanism comprising:
a clamp rocker bar disposed on the second support surface;
a clamp bolt extending from the second support surface;
a clamp nut on the clamp bolt; and
an angled clamp having a first end portion resting against the clamp rocker and an opposite second end pivoting about the first end to engage the wiper blade, the clamp bolt extending through the angled clamp and the clamp nut engaging the angled clamp to angularly bias the second end toward the wiper blade.

9. A conveyor belt system for moving bulk materials, the conveyor belt system comprising:
a frame;
a head pulley coupled to the frame;
a conveyor belt wrapped around the head pulley, the conveyor belt having an upper portion disposed above the head pulley, a wrapped portion wrapped around the head pulley, and a lower portion disposed below the head pulley without being wrapped around the head pulley;
a conveyor belt wiper coupled to the frame proximate the head pulley, the conveyor belt wiper comprising a wiper blade biased against the conveyor belt lower portion.

10. The conveyor belt system of claim 9, wherein the conveyor belt wiper blade is flexible and is flexed against the conveyor belt lower portion.

11. The conveyor belt system of claim 10, wherein the conveyor belt wiper blade includes a plurality of independently flexible fingers.

12. The conveyor belt system of claim 10, wherein the conveyor belt wiper blade includes a wear block attached to a distal end of the flexible conveyor belt wiper blade contacting the conveyor belt.

13. The conveyor belt system of claim 12, wherein the flexible conveyor belt wiper blade comprises carbon fiber and the wear block comprises one of ceramic and plastic.

14. The conveyor belt system of claim 12, wherein the flexible conveyor belt wiper blade comprises stainless steel and the wear block comprises tungsten carbide.

15. The conveyor belt system of claim 9, wherein the conveyor belt wiper further comprises a sprayer spraying a fluid at the conveyor belt.

16. A method of cleaning a conveyor belt that dumps bulk materials carried thereon as it turns about a head pulley while moving in a first direction, the conveyor belt having an upper portion disposed above the head pulley, a head pulley portion wrapping around the head pulley while dumping the bulk materials, and a lower portion disposed below the head pulley without wrapping around the head pulley, the method comprising:
flexing a distal end portion of a wiper blade against the lower portion of the conveyor belt, the distal end portion extending from a proximate end portion of the wiper blade in a second direction substantially opposite to the first direction in which the conveyor belt moves.

17. The method of claim 16, wherein the wiper blade includes a plurality of fingers at the distal end portion and the step of flexing includes flexing the fingers against the lower portion of the conveyor belt.

18. A conveyor belt wiper comprising:
a wiper blade support having a first support surface abutting a rearward portion of the wiper blade and a second support surface disposed at an angle from the first support surface;
a wiper blade attached to the wiper blade support; and
a blade clamping mechanism removably attaching the flexible wiper blade to the wiper blade support, the blade clamping mechanism comprising:
a clamp rocker bar disposed on the second support surface;
a clamp bolt extending from the second support surface;
a clamp nut on the clamp bolt; and
an angled clamp having a first end portion resting against the clamp rocker and an opposite second end pivoting about the first end to engage the wiper blade, the clamp bolt extending through the angled clamp and the clamp nut engaging the angled clamp to angularly bias the second end toward the wiper blade.

19. The conveyor belt wiper of claim 18, further comprising a tensioning mechanism biasing the wiper blade against a conveyor belt when operatively connected to a conveyor belt system.

20. The conveyor belt wiper of claim 19, wherein the wiper blade is flexible and the tensioning mechanism flexes the flexible wiper blade against the conveyor belt when operatively connected to the conveyor belt system.
